(19) United States
(12) Patent Application Publication
(10) Pub. No.: US 2011/0293277 A1
(43) Pub. Date: Dec. 1, 2011

(54) RECONFIGURABLE MULTI-ZONED FIBER OPTIC NETWORK ARCHITECTURE HAVING FIBER OPTIC DEVICES

(76) Inventors: Daniel Aurel Bradea, Victoria (AU); Peter Charles Ballhaussen, Hickory, NC (US)

(21) Appl. No.: 13/206,157

(22) Filed: Aug. 9, 2011

Related U.S. Application Data
(63) Continuation of application No. PCT/US10/23901, filed on Feb. 11, 2010.
(60) Provisional application No. 61/151,686, filed on Feb. 11, 2009.

(51) Int. Cl. H04J 14/00

(52) U.S. Cl. 398/66

(57) ABSTRACT

A fiber optic network having one or more zones is disclosed. Each zone of the fiber optic network includes one or more zone terminals or devices. Such zone terminals or devices may be located at a mid-span access point of a distribution cable optically connected to a service provider's feeder cable. The zone terminal has a plurality of connector ports with at least one adapter positioned within one of the plurality of connector ports. The adapter is configured to establish an optical connection with one or more optical fibers of the distribution cable. The second multi-fiber optical connector is suitable for outside-plant installation, and the terminal is configured to extend optical service from a service provider toward at least one subscriber premises in a zone. The fiber optic terminal is reconfigurable based on at least one of, a number of subscriber premises in the zone, a geographical relationship of the subscriber premises in the zone, and a demographic make-up of the subscriber premises in the zone.

### CROSS-REFERENCE TO RELATED APPLICATIONS

This application is a continuation of International Application No. PCT/US10/23901 filed Feb. 11, 2010, which claims the benefit of priority to U.S. Application No. 61/151,686, filed Feb. 11, 2009, both applications being incorporated herein by reference.

### BACKGROUND

1. Technical Field

The present invention relates generally to fiber optic devices, and more particularly to fiber optic devices arranged in multi-zoned distribution network architectures, which may be reconfigured to meet optical communication service requirements.

2. Technical Background

Optical fiber is increasingly being used for a variety of broadband applications including voice, video and data transmissions. As a result of the ever-increasing demand for broadband communications, telecommunication and cable media, service providers and/or operators are expanding their fiber optic networks to increase their networks' capacity and reach to provide more services, applications and information to more subscribers. To facilitate this capacity and reach, the fiber optic networks must employ additional fiber optic cable, hardware and components resulting in increased installation time, cost and maintenance. This results in the fiber optic networks becoming more complex, requiring architectures that allow for the most efficient delivery of fiber optic service to the subscriber. These architectures may be configured by employing fiber optic network devices, such as optical terminals, for example, in branches of the fiber optic network. The fiber optic network devices act to optically interconnect the fiber optic cables of the branch, separate or combine optical fibers in multi-fiber cables, and/or split or couple optical signals, as may be necessary for the configuration of the architecture.

### SUMMARY OF THE DETAILED DESCRIPTION

Embodiments disclosed in the detailed description include a fiber optic terminal, comprising an enclosure having a wall defining an interior cavity and a plurality of connector ports disposed through the wall. At least one adapter positions within one of the plurality of connector ports. The at least one adapter has an interior end accessible from within the interior cavity and an exterior end accessible external to the enclosure. The adapter is configured to establish an optical connection between at least one optical fiber attached to a first multi-fiber optical connector inserted in the interior end, and one or more respective optical fibers in a second multi-fiber optical connector inserted in the exterior end. The one or more respective optical fibers are optically connected to one or more optical fibers of a distribution cable. The second multi-fiber optical connector may be suitable for outside-plant installation. The terminal is configured to extend optical service from a service provider toward at least one subscriber premises in a zone. Additionally the fiber optic terminal is reconfigurable based on at least one of, a number of subscriber premises in the zone, a geographical relationship of the subscriber premises in the zone, and a demographic make-up of the subscriber premises in the zone.

The configuring may include splicing hardware positioned in the enclosure. The at least one optical fiber attached to the first multi-fiber optical connector may route to the splicing hardware and connect to a respective pigtail optical fiber. The configuring may also include one or more 1×N splitters. An optical signal carried by the optical fiber in the first fiber optic cable may be split into N optical signals where N may be 4. 8, 16 and 32. The N optical signals may be carried by a respective number of optical fibers.

Embodiments disclosed in the detailed description also include a fiber optic network having one or more zones. The fiber optic network may be a public network or a private network. Each zone of the fiber optic network includes one or more zone terminals or devices. Such zone terminals or devices may be located at a mid-span access point of a distribution cable optically connected to a service provider's feeder cable. The zone terminal has a plurality of connector ports with at least one adapter positioned within one of the plurality of connector ports. The adapter is configured to establish an optical connection with one or more optical fibers of the distribution cable. The second multi-fiber optical connector is suitable for outside-plant installation, and the terminal is configured to extend optical service from a service provider toward at least one subscriber premises in a zone. The fiber optic terminal is reconfigurable based on at least one of, a number of subscriber premises in the zone, a geographical relationship of the subscriber premises in the zone, and a demographic make-up of the subscriber premises in the zone.

In this way, the service provider can initially configure the zone for the current number of subscribers, for example single family units, to be connected to the fiber optic network. As an example, this may be 30% of the subscribers, referred to as a 30% take rate. The service provider can defer the cost for the rest of the current and/or future subscribers. Only at the time the demand for optical communication service changes, for example increasing to a 50% or higher take rate level, does the service provider incur the cost to reconfigure the zone to meet that 50% or higher take rate. Additionally, the reconfiguration may be done at minimal cost and labor, particularly since the optical components and hardware may employ plug and play connections.

### BRIEF DESCRIPTION OF THE FIGURES

FIG. 1 is an exemplary schematic diagram of a portion of a multi-zoned fiber optic network architecture having exemplary zone terminals and a mid-span access point attached to distribution cables;

FIG. 2 is a schematic diagram of an exemplary zone terminal having connector ports and a splice tray included in the multi-zoned fiber network architecture of FIG. 1;

FIG. 3 is a schematic diagram of an exemplary zone terminal having connector ports included in the multi-zoned fiber network architecture of FIG. 1;

FIG. 4 is a schematic diagram of an exemplary branch-connected terminal included in the multi-zoned fiber network architecture of FIG. 1;

FIG. 5 is a schematic diagram of an exemplary series-connected terminal included in the multi-zoned fiber network architecture of FIG. 1;

FIG. 6 is a schematic diagram of an exemplary series-connected terminal included in the multi-zoned fiber network architecture of FIG. 1, and wherein a 1×4 splitter is disposed in the series-connected terminal;

FIG. 7 is a schematic diagram of an exemplary drop terminal included in the multi-zoned fiber network architecture of FIG. 1;

FIG. 8 is a schematic diagram of an exemplary drop terminal included in the multi-zoned fiber network architecture of FIG. 1, and wherein a 1×8 splitter is disposed in the drop terminal;

FIG. 9 is a schematic diagram of an exemplary drop terminal included in the multi-zoned fiber network architecture of FIG. 1, and wherein a 1×4 splitter is disposed in the drop terminal;

FIG. 10 is a perspective view of a zone terminal having a plurality of connector ports according to an exemplary embodiment;

FIG. 11 is a perspective view of the zone terminal of FIG. 10 with the cover in an opened position;

FIG. 12 is a is a view of an optical terminal which may be used as a branch-connected terminal, according to an exemplary embodiment;

FIG. 13 is a view of an optical terminal which may be used as a series-connected terminal, according to an exemplary embodiment; and

FIG. 14 is a view of an optical terminal which may be used as a drop terminal, according to an exemplary embodiment.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

To facilitate the description of the various embodiments, the terms “optical terminal,” “fiber optic terminal,” “zone terminal,” “branch-connected terminal”, and/or “series-connected terminal” may be used. It should be understood that as used herein these terms are not limited to any specific type, style, structure, construction or arrangement of fiber optic network device. Accordingly, for purposes herein “optical terminal,” “fiber optic terminal,” “zone terminal,” “branch-connected terminal,” and/or “series-connected terminal” shall mean and include, but not be limited to, devices and/or structures which may typically be referred to as a local convergence point, a fiber distribution hub, a fiber distribution cabinet, a splitter cabinet, a multiport, a fiber terminal, a multiple dwelling closure, a local convergence cabinet, a pedestal, a network access point, a distribution closure, and the like.

The terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets, or the like. Likewise, other types of suitable optical fibers include bend-insensitive optical fibers, or any other expedient of a medium for transmitting light signals. An example of a bend-insensitive optical fiber is ClearCurve® Multimode fiber commercially available from Corning Incorporated.

Further, as used herein and well known and understood in the art, “feeder cable” shall mean and include any one or more of fiber optic cables from a central office of a telecommunications service provider or operator, or a transport cable from a head end of cable media service provider or operator. The term “distribution cable” shall mean any cable optically connected to a feeder cable or a transport cable, either directly or through a fiber optic component, including, but not limited to, a splitter, and used to further distribute the optical services toward a subscriber premises. The term “branch cable,” “sub-branch cable,” “series cable,” “tether cable,” and/or “stub cable” shall mean and include any fiber optic cable that may optically connect, directly or indirectly, to and/or extend from a distribution cable and/or a feeder cable for the purpose of optically connecting the distribution cable to a drop cable. The term “drop cable” shall mean and include a fiber optic cable extending to a subscriber premises. The feeder cable, distribution cable, branch cable, sub-branch cable, series cable, tether cable, stub cable and/or drop cable may be any type of fiber optic cable having one or more optical fibers.

The drop cable may be, “pre-connectorized” to be readily connected to and disconnected from a drop port of an optical terminal. At the other end, the drop cable may be optically coupled to optical fibers within a conventional closure or optical network terminal (ONT), such as, but not limited to, a network interface device (NID) of the types available from Corning Cable Systems LLC of Hickory, N.C. In the exemplary embodiments shown and described herein, the drop cables extend from a closure located at a subscriber premises and are optically coupled through the drop ports of an optical terminal to optical fibers of the distribution cable, either directly or indirectly through a branch cable, a sub-branch cable, a series cable, a tether cable, and/or a stub cable, or other optical components, such as a splitter. Additionally, the optical fibers of the distribution cable may be optically connected to the feeder cable, and, thus, to the central office. As such, the optical terminal provides an accessible interconnection terminal for readily connecting, disconnecting or reconfiguring distribution cables, branch cables, sub-branch cables, series cables, tether cables, stub cables and/or drop cables, and optical components and hardware in the optical network, and, thereby reconfiguring the architecture of the optical network.

The terms connect, interconnect, and couple shall be understood to mean, without limitation, the passage, flow, transmission, or the like of an optical signal between one or more of optical cables, optical fibers, components, and/or connectors, or the like and one or more of optical cables, optical fibers, components, and/or connectors, or the like; whether or not by direct or indirect physical connection, to establish optical communication or connectivity thereby. The optical terminal may be adapted to accommodate a variety of connector types, such as but not limited to simplex and/or duplex SC, LC, DC, FC, ST, SC/DC, MT-RJ, MTP, MPO connectors. Further, the optical terminal may be adapted to accommodate ruggedized connectors for outside plant installations. Examples of such ruggedized connectors include, OptiTap® or OptiTip® connectors available from Corning Cable Systems LLC of Hickory, N.C.

For purposes herein, reference to “upstream” shall mean in the direction toward the central office. Reference to “downstream” shall mean in a direction toward the subscriber premises. It should be understood, though, that using the terms “upstream” or “downstream” does not indicate the direction in which the optical signals are transmitted or carried in the optical fibers. Thus, an optical signal may be transmitted in both the upstream and/or the downstream direction.

Embodiments disclosed in the detailed description include a fiber optic terminal, comprising an enclosure having a wall defining an interior cavity and a plurality of connector ports disposed through the wall. At least one adapter positions within one of the plurality of connector ports. The at least one adapter has an interior end accessible from within the interior cavity and an exterior end accessible external to the enclosure. The adapter is configured to establish an optical connection between at least one optical fiber attached to a first multi-fiber optical connector inserted in the interior end, and one or more respective optical fibers in a second multi-fiber optical connector inserted in the exterior end. The one or more respective optical fibers are optically connected to one or more optical fibers of a distribution cable. The second multi-fiber optical connector may be suitable for outside-plant installation. The terminal is configured to extend optical service from a service provider toward at least one subscriber premises in a zone. Additionally the fiber optic terminal is reconfigurable based on at least one of, a number of subscriber premises in the zone, a geographical relationship of the subscriber premises in the zone, and a demographic make-up of the subscriber premises in the zone.

The configuring may include splicing hardware positioned in the enclosure. The at least one optical fiber attached to the first multi-fiber optical connector may route to the splicing hardware and connect to a respective pigtail optical fiber. The configuring may also include one or more 1×N splitters. An optical signal carried by the optical fiber in the first fiber optic cable may be split into N optical signals where N may be 4. 8, 16 and 32. The N optical signals may be carried by a respective number of optical fibers.

Embodiments disclosed in the detailed description include a fiber optic network having one or more zones. The fiber optic network may be a public network or a private network. Each zone of the fiber optic network includes one or more zone terminals or devices. Such zone terminals or devices may be located at a mid-span access point of a distribution cable optically connected to a service provider's feeder cable. The zone terminal has a plurality of connector ports with at least one adapter positioned within one of the plurality of connector ports. The adapter is configured to establish an optical connection with one or more optical fibers of the distribution cable. The second multi-fiber optical connector is suitable for outside-plant installation, and the terminal is configured to extend optical service from a service provider toward at least one subscriber premises in a zone. The fiber optic terminal is reconfigurable based on at least one of, a number of subscriber premises in the zone, a geographical relationship of the subscriber premises in the zone, and a demographic make-up of the subscriber premises in the zone.

In this way, the service provider can initially configure the zone for the current number of subscribers, for example single family units, to be connected to the fiber optic network. As an example, this may be 30% of the subscribers, referred to as a 30% take rate. The service provider can defer the cost for the rest of the current and/or future subscribers. Only at the time the demand for optical communication service changes, for example increasing to a 50% or higher take rate level, does the service provider incur the cost to reconfigure the zone to meet that 50% or higher take rate. Additionally, the reconfiguration may be done at minimal cost and labor, particularly since the optical components and hardware may employ plug and play connections.

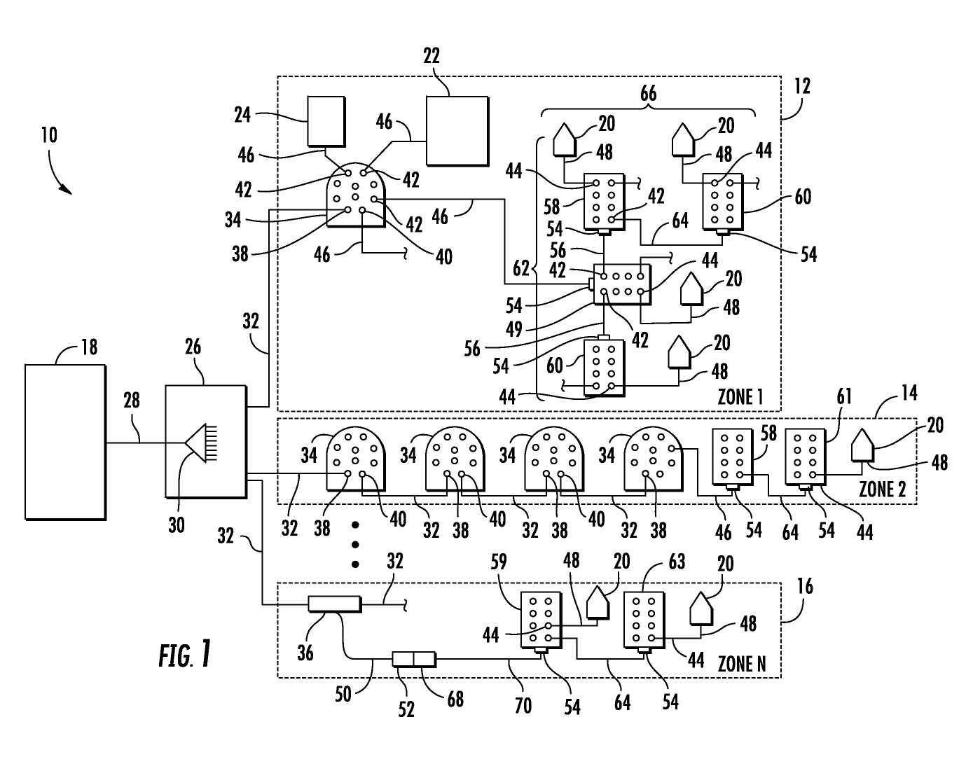

Referring now to FIG. 1, there is shown a fiber optic network 10 having a zoned distribution architecture. In FIG. 1, multiple zones are shown, “Zone 1” 12, “Zone 2” 14 and “Zone N” 16. It should be understood that the fiber optic network may have an architecture based on any number of zones, including 1 zone and any multiple of zones, which is indicated by the designation “Zone N” 16. Each zone is a portion of the fiber optic network 10 and may be configured and reconfigured, as necessary, to facilitate the provision of optical communication service from the service provider to subscribers within the zone. The configuring and reconfiguring may be based on geographical relationship of the subscriber premises in the zone, demographic make-up of the subscriber premises in the zone. This may be accomplished by providing optical connectivity from the central office 18 to the subscriber premises, which may be a single family unit 20, a multiple dwelling unit (MDU) 22 or a commercial building 24, which shall include, without limitation, educational, institutional buildings, and the like, and combinations thereof. Additionally, the MDU 22 and/or the commercial building 24 may comprise a plurality of buildings and/or structures, including, but not limited to, buildings and/or structures organized into a campus.

Configuring and/or reconfiguring a zone may involve, without limitation, providing different types and quantity of optical terminals and fiber optic cables. The optical terminals provide intermediate points or nodes for providing and accessing optical components and the fiber optic cables. Thus, configuring a zone may involve the manner in which the optical terminals and/or optical components are interconnected by the fiber optic cables. In this manner, the optical terminals and optical components may be provisioned, configured and interconnected in the fiber optic network 10 to facilitate providing optical service to the subscribers in the zone. Additionally, if the quantity and types of subscribers change over time, the zone may be reconfigured. In this manner, the optical terminals, optical components and fiber optic cables in that particular zone, may be accessed and changed without having to access or change the optical terminals, optical components and/or fiber optic cables in another zone or portion of the fiber optic network 10. In this manner, one or more zones in the fiber optic network may be independently reconfigurable. As mentioned above, the zone may include optical components and solutions which employ plug and play connections, which may result in minimal costs and labor to reconfigure the zone.

In the embodiment shown in FIG. 1, an optical terminal in the form of a fiber distribution hub (FDH) 26 is positioned in the fiber optic network 10 downstream from the central office 18. The FDH 26 receives a feeder cable 28 extended from the central office 18. In this manner, the optical components in the FDH 26 may be optically connected to the equipment in the central office 18. The feeder cable 28 may be connectorized. The optical components in the FDH 26 may include, but not be limited to, one or more distribution splitters 30. Typically, the feeder cable 28 is a multi-fiber optical cable, having for example 12-24 optical fibers. One or more of the optical fibers in the feeder cable 28 may be optically connected to one or more of the distribution splitters 30. The distribution splitters 30 may split the optical signals carried by the optical fibers in the feeder cable 28 into multiple split optical signals. As examples, the distribution splitter 30 may be any ratio of split, including, without limitation 1×4, 1×8, 1×16, 1×32, 2×4, and 2×8.

The split optical signals may then be carried by one or more distribution cables 32, each having multiple optical fibers. The distribution cable 32 may have any number of optical fibers. As non-limiting examples, a distribution cable 32 may have 12, 24, 48, 72 or 96 optical fibers. In the embodiment shown in FIG. 1, three distribution cables 32 extend from the FDH 26 to a respective zone, “Zone 1” 12, “Zone 2” 14, and “Zone N” 16 of the fiber optic network 10. Although three distribution cables 32 are shown in FIG. 1, it should be understood that any number of distribution cables 32 may extend from the FDH 26 to respective zones. Each distribution cable 32 extends optical communication service to the respective zone.

The distribution cables 32 extend to optical devices in the respective zones. In the embodiment shown in FIG. 1, the distribution cables 32 extending to “Zone 1” 12 and “Zone 2” 14 each extends from the FDH 26 to a zone terminal 34. While in “Zone N” 16, the distribution cable 32 extends from the FDH 26 to a mid-span access point 36. It should be understood, though, that either or both “Zone 1” 12 and “Zone 2” 14 can have a mid-span access point 36, and “Zone N” 16 can have a zone terminal 34. The zone terminal 34 has an upstream cable port 38 and a downstream cable port 40. The distribution cable 32 may enter or connect to the zone terminal 34 at the upstream cable port 38. In certain configurations, the distribution cable 32 may exit or connect to the zone terminal 34 at the downstream cable port 40 to allow the distribution cable 32 to continue downstream from the zone terminal 34. The upstream cable port 38 and the downstream cable port 40 may provide for the distribution cable to pass directly into the zone terminal 34. Alternatively, a multi-fiber connector adapter (not shown) may be seated in one or both of the upstream cable port 38 and the downstream cable port 40. In this manner, the distribution cable 32 may have a multi-fiber connector at its end (not shown) which may be received by the multi-fiber connector adapter.

The zone terminal 34 may also have other connector ports. In FIG. 1, the zone terminal 34 in “Zone 1” 12 is shown as having eight other connector ports, but the zone terminal 34 may have any number of other connector ports, including as non-limiting examples 12 and 16. Depending on the particular configuration of the zone terminal 34, a multi-fiber adapter or a single fiber adapter may be seated in the connector port. The connector ports may act as branch ports 42 or drop ports 44. Branch cables 46 connect to the branch ports 42 at the connector adapter and extend to other optical terminals downstream. Drop cables 48 connect to the drop ports 44 and extend to subscriber premises. In FIG. 1, three branch cables 46 are shown extending from respective the branch ports 42 in the zone terminal 34 in “Zone 1” 12. One branch cable 46 extends to the multiple dwelling unit (MDU) 22 and another branch cable 46 extends to the commercial building 24. These branch cables may connect to optical terminals (not shown) in the MDU 22 and commercial building 24. One or more drop cables 48 may then extend from the optical terminals. Although not shown in FIG. 1, the configuration of “Zone 1” 12 may be such that a drop cable 48 may also extend from the zone terminal 34 to, for example, a single family unit 20. The branch cables 46 may extend from the zone terminal 34 to another optical terminal in the zone. In “Zone 1” 12, one of the branch cables 46 extends from the zone terminal 34 to branch-connected terminal 49. The branch cables 46 in this embodiment may have, for example, 12 optical fibers. However, the branch cable 46 may have any number of optical fibers based on the configuration of the architecture of “Zone 1” 12. Although the zone terminal 34 in “Zone 1” 12 in FIG. 1 is shown with a certain configuration of connector ports, it should be understood that the zone terminal 34 may be initially configured and subsequently reconfigured with any number or combination of types of connector ports.

In “Zone 1” 12, the fiber optic network 10 includes other optical terminals downstream from the zone terminal 34. As mentioned above, one of the branch cables 46 extends from the zone terminal 34 to the branch-connected terminal 49. The branch cable 46 enters into or connects with the branch-connected terminal 49 at a network port 54. Sub-branch cables 56 extend from branch ports 42 in the branch-connected terminal 49 to a series-connected fiber optic terminal 58 and to a drop terminal 60, respectively. The sub-branch cables 56 enter into or connect with the series-connected terminal 58 and the drop terminal 60 at respective network ports 54. In the embodiment shown in FIG. 1 for “Zone 1” 12, the sub-branch cables 56 may have four optical fibers each. However, the sub-branch cable 56 may have any number of optical fibers based on the configuration of the architecture of “Zone 1” 12.

The arrangement of the branch-connected terminal 49 with the series-connected terminal 58 and the drop terminal 60 forms a branched network segment 62. The branched network segment 62 may be utilized in providing service to subscriber premises in cases where the branch-connected terminal 49 may be located somewhat centrally among a cluster of subscriber premises. The series-connected terminal 58 and the drop terminal 60 may be positioned at or near opposite ends of the cluster of subscriber premises. This positioning may then facilitate the routing of drop cables 48 to the subscriber premises. This is illustrated in the embodiment in FIG. 1, by the drop cables 48 extending from drop ports 44 in the branch-connected terminal 48, the series-connected terminal 58 and the drop terminal 60 to single family units 20. It should be noted that it is not necessary that a branch network segment be arranged as shown in FIG. 1 with a series-connected terminal 58 and a drop terminal 60. As such, a branched network segment 62 may include any type or number of optical terminals.

Continuing with the “Zone 1” 12, a series cable 64 extends from the branch port 42 of the series-connected fiber optic terminal 58 to another drop terminal 60. The series cable 64 enters into or connects with the drop terminal 60 at the network port 54. The arrangement of the series-connected fiber optic terminal 58 connected to the drop terminal 60 by the series cable 64 forms a series network segment 66. Although in FIG. 1, only one series-connected fiber optic terminal 58 is shown in the series network segment 66, a series network segment 66 may include more than one series-connected fiber optic terminal 58. The series cable 64 in this embodiment may have four to eight optical fibers. However, the series cable 64 may have any number of optical fibers based on the configuration of the architecture of “Zone 1” 12. The series network segment 66 may be utilized in providing service to subscriber premises in cases where the subscriber premises are not clustered in a manner that may facilitate a branched network segment 62 and/or are spaced at longer distances apart.

An example of a different network configuration is shown in “Zone 2” 14 of FIG. 1. In “Zone 2” 14 multiple zone terminals 34 are connected in series along a length of the distribution cable 32. The distribution cable 32 extends to and from each zone terminal 32 at the upstream cable port 38 and the downstream cable port 40. Branch cable 46 may extend from one or more branch port 42 of a zone terminal 34 to a series-connected terminal 58. The branch cable 46 in this embodiment may have four to eight optical fibers. However, the branch cable 46 may have any number of optical fibers based on the configuration of the architecture of “Zone 2” 14. Although in FIG. 1 only one series-connected terminal 58 is shown in “Zone 2” 14, that is only for ease of discussing the configuration of “Zone 2” 14. Therefore, it should be understood that any number of series-connected terminals 58 may be optically connected to each of the zone terminals 34. For example, four series-connected terminals 58 may be optically connected by branch cables 46 to each zone terminal 34. Series cable 64 may extend from one or more branch port 42 on the series-connected terminal 34 to a drop terminal 61. The series cable 64 in this embodiment may have a single optical fiber. However, the series cable 64 may have any number of optical fibers based on the configuration of the architecture of “Zone 2” 14. Although in FIG. 1 only one drop terminal 61 is shown in “Zone 2” 14, that is only for ease of discussing the configuration of “Zone 2” 14. Therefore, it should be understood that any number of drop terminals 61 may be optically connected to each of the series-connected terminals 58. For example, eight drop terminals 61 may be optically connected by series cables 64 to each series-connected terminal 58. Drop cables 48 may extend from one or more drop ports 44 on the drop terminals 61 to subscriber premises, for example, a single family unit 20. In this manner, the architecture of “Zone 2” 14 may provide optical communication service to up to 385 single family units 20, or more.

Continuing with reference to FIG. 1, a mid-span access point 36 is shown in “Zone N” 16. At the mid-span access point 36, a certain number of optical fibers is separated out from the other optical fibers in the distribution cable 32. The separated out optical fibers are contained in a tether cable 50 which extends from the mid-span access point 36. The tether cable 50 may be terminated by a single fiber or multi-fiber tether connector 52 based on the configuration of “Zone N” 16. Alternatively or additionally, the tether cable 50 may extend to another optical terminal in “Zone N” 16 to optically connect that optical terminal to the distribution cable 32. The distribution cable 32, less the optical fibers separated out into the tether cable 50 continues downstream. Additional mid-span access points 36 may be located on the distribution cable 32 as the distribution cable extends downstream. A mid-span access point may also be located at the downstream end of the distribution cable 32. It should be noted that a zone may have both zone terminals 34 and mid-span access points 36.

In the configuration of “Zone N” 16, the tether connector 52 connects to a stub connector 68 attached to the end of a stub cable 70. The stub connector may be single fiber or multi-fiber based on the configuration of “Zone N” 16. Accordingly, the stub cable 70 may have a single optical fiber or multiple optical fibers. The stub cable 70 extends from network port 54 of series-connected terminal 59. Series cable 64 extends from branch port 42 on the series-connected terminal 59 to the network port 54 of the drop terminal 63. Drop cables 48 may extend from drop ports 44 in the series-connected terminal 59 and the drop terminal 60 to subscriber premises, for example single family units 20. In the configuration of “Zone N” 16, the tether connector 52, stub connector 68, series-connected terminal 58 and drop terminal 60 may be co-located in one enclosure, for example a pedestal enclosure. This configuration provides a convenient, reconfigurable and expandable network access point to meet the current and future subscriber demand for optical communication service in “Zone N” 16.

It should be noted that the network port 54 may provide for the branch cable 46, the sub-branch cable 56, the series cable 64, and the stub cable 70 to pass directly into the branch-connected fiber optic terminal 48, the series-connected terminal 58 and/or the drop terminal 60, as the case may be. Alternatively, a multi-fiber or single fiber connector adapter (not shown in FIG. 1) may be seated in the network port 54. In this manner, the branch cable 46, the sub-branch cable 56, the series cable 64, and/or the stub cable 70 may have a multi-fiber or single fiber connector at its end (not shown in FIG. 1) which may be received by the multi-fiber or single fiber connector adapter.

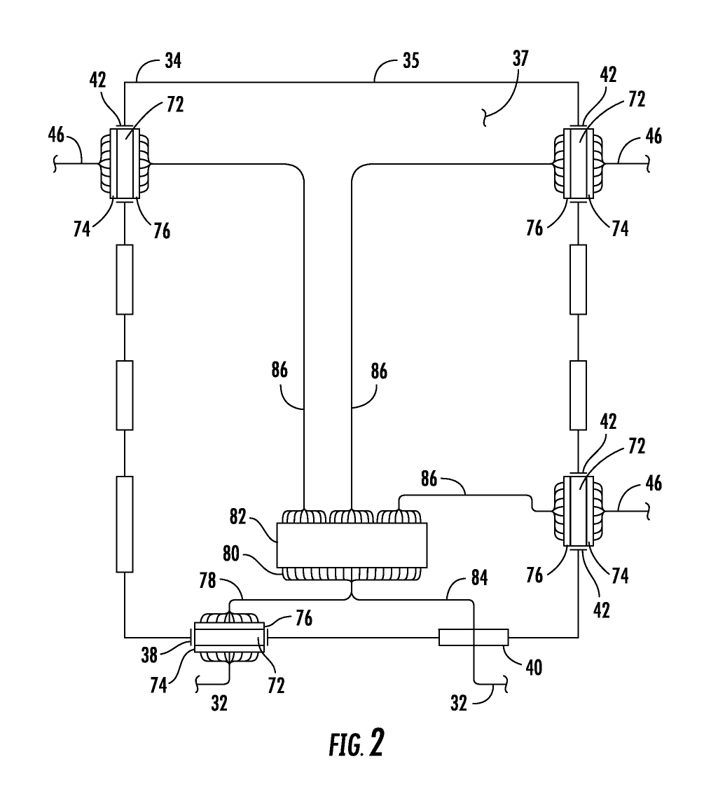

Referring now to FIG. 2, there is shown a schematic diagram of the zone terminal 34 in “Zone 1” 12 of FIG. 1. The zone terminal 34 has an enclosure 35 which defines an interior 37. The distribution cable 32 connects to the zone terminal 34 at the upstream cable port 38. The upstream cable port 38 and the downstream cable port 40 extend through the enclosure 35. In the embodiment shown in FIG. 2 a multi-fiber adapter 72 is seated in the upstream cable port 38. The end of the distribution cable 32 external to the zone terminal 34 may be terminated with a ruggedized multi-fiber optic connector 74, for example an OptiTip connector, which may be received by the multi-fiber adapter 72 at an external end. A multi-fiber connector 76, for example an MTP connector, may be received by the multi-fiber adapter 72 at an internal end in the interior 37. In such case, the multi-fiber adapter 72 will provide for the mating of an OptiTip connector with the MTP connector.

Optical fibers 78 are connected to the multi-fiber connector 76 and, therefore, are optically connected to the optical fiber of the distribution cable 32. The optical fibers 78 route in the interior 37 of the zone terminal 34 with certain of the optical fibers 80 connecting to a splicing hardware 82, which may be, for example, a splice tray. Other optical fibers 84 route to the downstream port 40. In this embodiment, the downstream port 40 does not have an adapter, and therefore the optical fibers 84 are included in a jacketed portion of the distribution cable 32 exiting from the zone terminal 34 through the downstream port 40.

The optical fibers 80 connecting to the splicing hardware 82 are spliced to pigtail optical fibers 86. The pigtail optical fibers 86 route from the splicing hardware 82 to branch ports 42 which extend through the enclosure wall of the zone terminal 34. The pigtail optical fibers 86 are terminated with a multi-fiber connector 76 which is received by a multi-fiber adapter 72 seated in the branch port 42 in the interior 37. Branch cable 46 may be terminated with a ruggedized multi-fiber optic connector 74. The ruggedized multi-fiber optic connector 74 is received by the multi-fiber adapter 72 external to the zone terminal 34. In this manner, the pigtail optical fibers 86 are optically connected to the optical fibers of the branch cable 46 through the multi-fiber adapter 72. The branch cables 46 may then extend to the MDU 22, commercial building 24 and branch-connected terminal 49 as shown in “Zone 1” 12 in FIG. 1. Additionally or alternatively, the zone terminal 34 may include one or more 1×N optical splitters. Further, the splice hardware 82, optical splitter, and/or other components may be cassette mounted for ease of and minimal cost installation. In this manner, for example, a cassette splitter may be mounted in the zone terminal but not connected until the zone needs to be reconfigured do to a change in subscriber take rate. At that time, the service provider can just connect the cassette splitter to provide for optical communication service to additional subscribers.

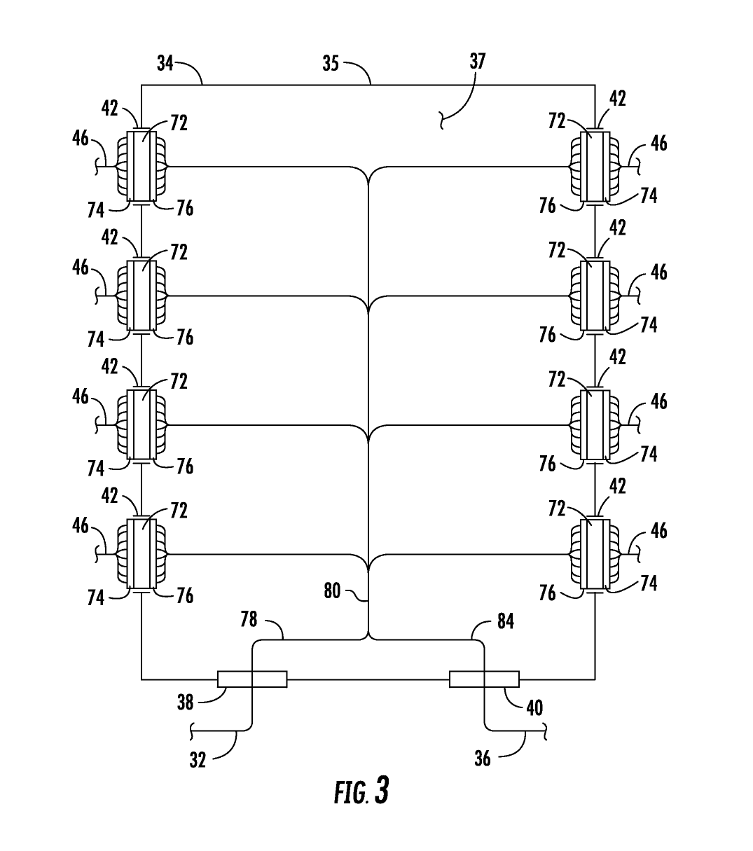

Referring now to FIG. 3, there is shown a schematic diagram of the zone terminal 34 in “Zone 2” 14 of FIG. 1. The zone terminal 34 in “Zone 2” 14 is configured differently than the zone terminal 34 in “Zone 1” 12. In the embodiment shown in FIG. 3, the distribution cable 32 enters the interior 37 of the zone terminal 34 through the upstream cable port 38. The jacket of the distribution cable 32 may be stripped off in the interior 37 such that the optical fibers 78 of the distribution cable 32 may be loose to facilitate routing within the interior 37 as necessary to configure the zone terminal 34. In FIG. 3, certain optical fibers 80 of the distribution cable 32 route to the branch ports 42. In this embodiment, the zone terminal 34 is shown as having eight branch ports 42. Four to eight optical fibers 80 terminated with a multi-fiber optic connector 76 may be routed to each branch port 42. As discussed above with respect to the pigtail optical fibers 86 shown in FIG. 2, the optical fibers 80 may be terminated with a multi-fiber connector 76 and be optically connected to the optical fibers of the branch cable 46 through the multi-fiber adapter 72. Each branch cable 46 may be terminated with a ruggedized multi-fiber connector 74 which is received by the multi-fiber adapters 72 in each branch port 42. Each branch cable 46 then extends to a respective series-connected terminal 58 as shown in “Zone 2” 14 in FIG. 1.

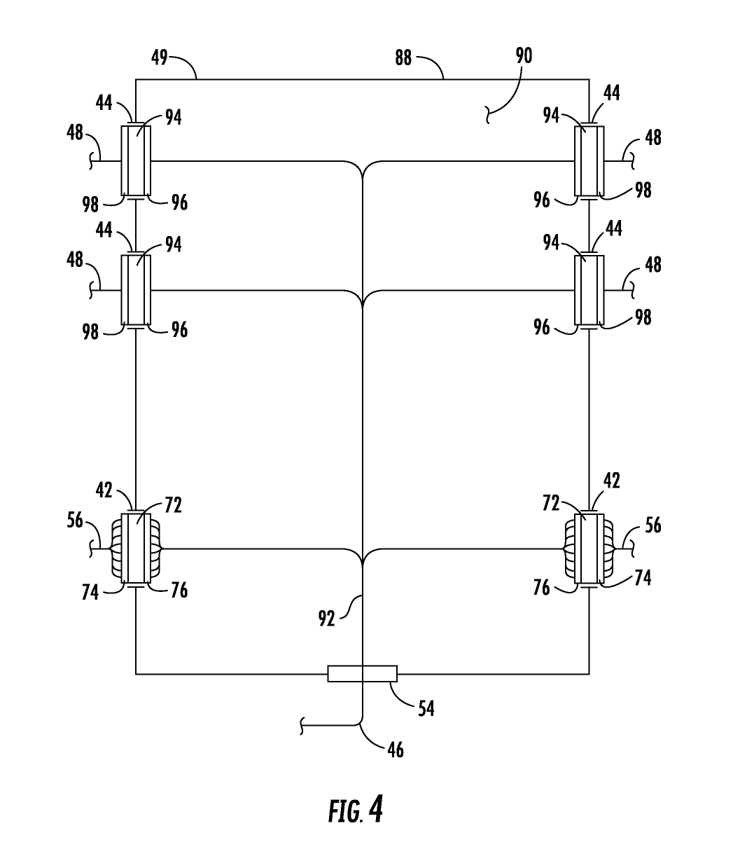

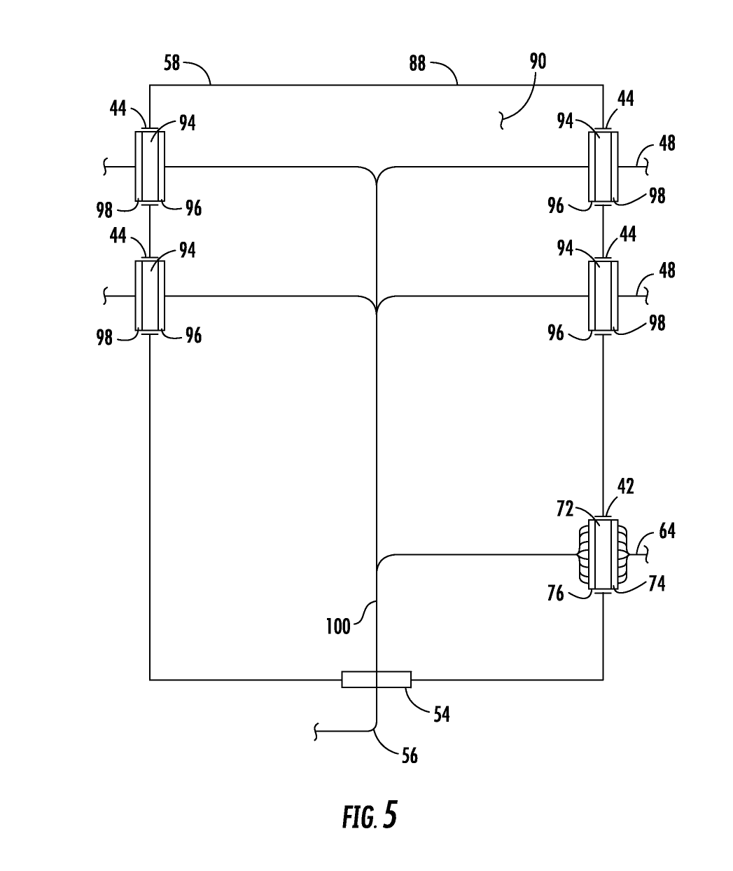

Referring now to FIGS. 4 and 5, there are shown schematic diagrams of the branch-connected terminal 49 and the series-connected terminal 58, respectively. FIGS. 4 and 5 will be discussed together as the branch-connected terminal 49 and the series-connected terminal 58 have similar, although not identical, configurations. The branch-connected terminal 49 and series-connected terminal 58 each has an enclosure 88 defining an interior 90. The branch cable 46 enters the branch-connected terminal 49 (FIG. 4) and the sub-branch cable 64 enters series-connected terminal 58 (FIG. 5) through network port 54 in their respective enclosures 88. The jacket of the branch cable 46 may be stripped off in the interior 90 such that the optical fibers 92 of the branch cable 46 may be loose to facilitate routing within the interior 90 as necessary to configure the branch-connected terminal 49. In FIG. 4, the optical fibers 92 of the branch cable 46 are shown routed to two branch ports 42 and four drop ports 44. Four to eight optical fibers 92 may be terminated with the multi-fiber connector 76 and routed at each branch port 42. The multi-fiber connector 76 is received by a multi-fiber adapter 72 seated in the branch ports 42. Sub-branch cables 56 may be terminated with ruggedized multi-fiber optic connectors 74 and received by the multi-fiber adapter 72. In this manner, the optical fibers 92 may be optically connected to the optical fibers of the sub-branch cable 56 through the multi-fiber adapter 72.

The sub-branch cable 56 may then extend to the series-connected terminal 58 (FIG. 5). In FIG. 5, the optical fibers 100 of the sub-branch cable 56 are shown routed to one branch port 42 and four drop ports 44. Four to eight optical fibers 100 may be terminated with the multi-fiber connector 76 and routed to the branch port 42. The multi-fiber connector 76 is received by a multi-fiber adapter 72 seated in the branch port 42. Series cable 64 may be terminated with ruggedized multi-fiber optic connectors 74 and received by the multi-fiber adapter 72. In this manner, the optical fibers 100 may be optically connected to the optical fibers of the series cable 64 through the multi-fiber adapter 72.

Referring again to FIG. 4, the optical fiber 92 routed to the drop ports 44 in the branch-connected terminal 49 may be terminated with a single fiber connector 96, for example an SC connector. The connector 96 may be received by an optical adapter 94 seated in the drop port 44. A drop cable 48 may be terminated by a ruggedized single fiber connector 98, for example, an OptiTap connector. The drop cable 48 may thereby be optically connected to the optical fiber 92 of the branch cable 46. Similarly, with reference to FIG. 5, the optical fiber 100 routed to the drop ports 44 in the series-connected terminal 60 may be terminated with a single fiber connector 96, for example an SC connector. The connector 96 may be received by an optical adapter 94 seated in the drop port 44. A drop cable 48 may be terminated by a ruggedized single fiber connector 98, for example, an OptiTap connector. The drop cable 48 may thereby be optically connected to the optical fiber 100 of the sub-branch cable 56.

It should be noted that the configuration of the branch-connected terminal 49 and/or a series-connected terminal 58 may involve the seating of a multi-fiber adapter 72 in a drop port 44 in order to accept multi-fiber connectors 74 and ruggedized multi-fiber connector 76. In such case, the manner in which the optical fibers connect at the drop port 44 will be the same as that described above with regard to the branch port 42. Additionally, the branch-connected terminal 49 and series-connected terminal 58 may have any number and combination of branch ports 42 and drop ports 44 with any number of optical fibers routed to each, both based on the configuration of the zone.

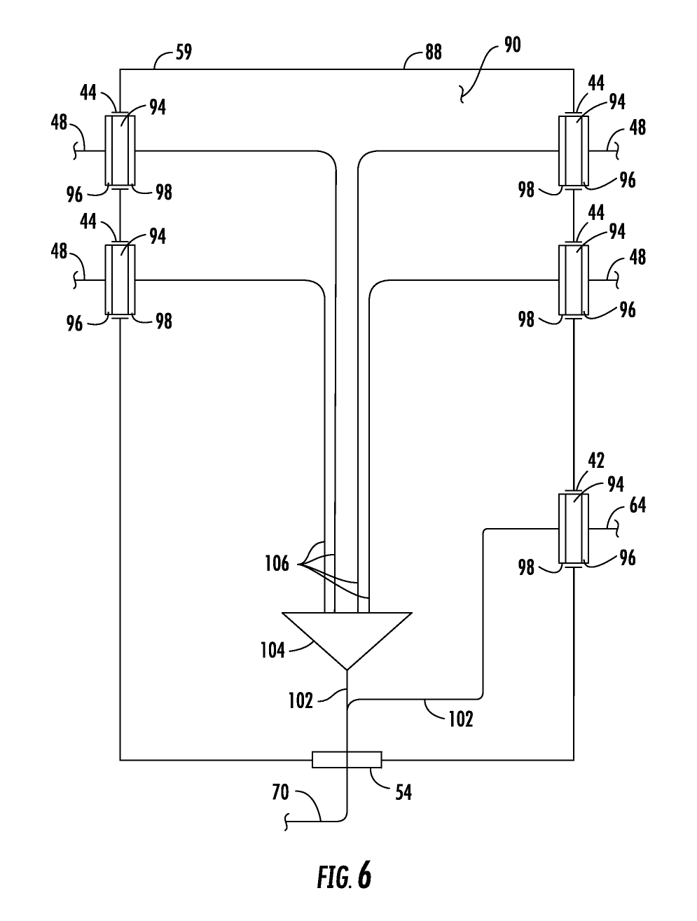

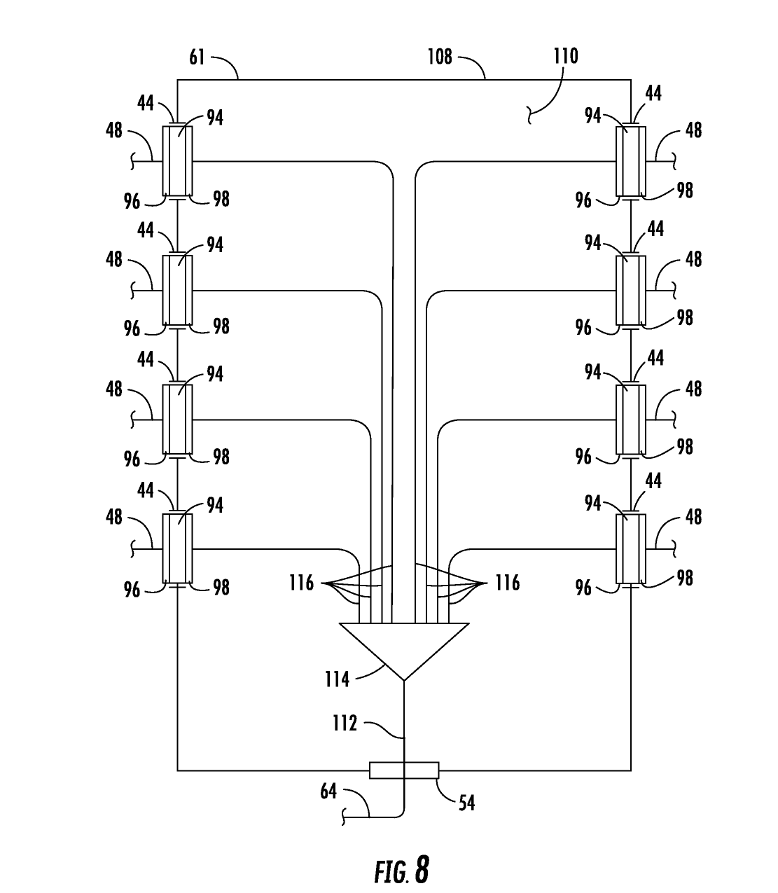

Referring now to FIG. 6, there is shown a schematic diagram of an embodiment of a series-connected terminal 59 included in the configuration of “Zone N” 16 in FIG. 1. The series-connected terminal 59 has an enclosure 88 defining an interior 90. In the embodiment shown in FIG. 6, the stub cable 70 has two optical fibers 102 and enters the series-connected terminal 59 through the network port 54 in the enclosure 88. The jacket of the stub cable 70 may be stripped off in the interior 90 such that the optical fibers 102 of the stub cable 70 may be loose to facilitate routing within the interior 90 as necessary to configure the series-connected terminal 59. One of the optical fibers 102 of the stub cable 70 routes to a branch port 42. In FIG. 6, the optical fiber 102 routed to the branch port 42 may be terminated with a single fiber connector 96. Since only a single optical fiber 102 is routed to the branch port 42, the branch port may be configured in the same manner as a drop port 44, with a single fiber optical adapter 94 seated in the branch port 42. The connector 96 may be received by the adapter 94 in the interior 90. The adapter 94 may receive external to the enclosure 88 a ruggedized single fiber connector 98 terminating the end of a series cable 64. The series cable 64 may thereby be optically connected to the optical fiber 92 of the stub cable 70. The series cable 64 may then route to a drop terminal 61 (FIG. 8) to provide expansion ability to “Zone N” 16 if it becomes necessary to reconfigure “Zone N” 16.

The other optical fiber 102 of the stub cable 70 routes to a 1×4 splitter 104. The optical signal in the optical fiber 102 is split into four optical signals each of which is carried by a pigtail optical fiber 106. Each of the pigtail optical fibers 106 is terminated with a connector 98 and routes to respective drop ports 44. The pigtail optical fiber 106 optically connects to the drop cable 48 through the adapter 94 seated in the drop port 44 in the same manner as described above with respect to drop ports 44. It should be noted that the stub cable 70 may have any number of optical fibers 120. Accordingly, more than one optical fiber 120 may route to the branch port 42. The branch port 42 may then be configured with a multi-fiber adapter 72 to accept multi-fiber connectors 74, 76.

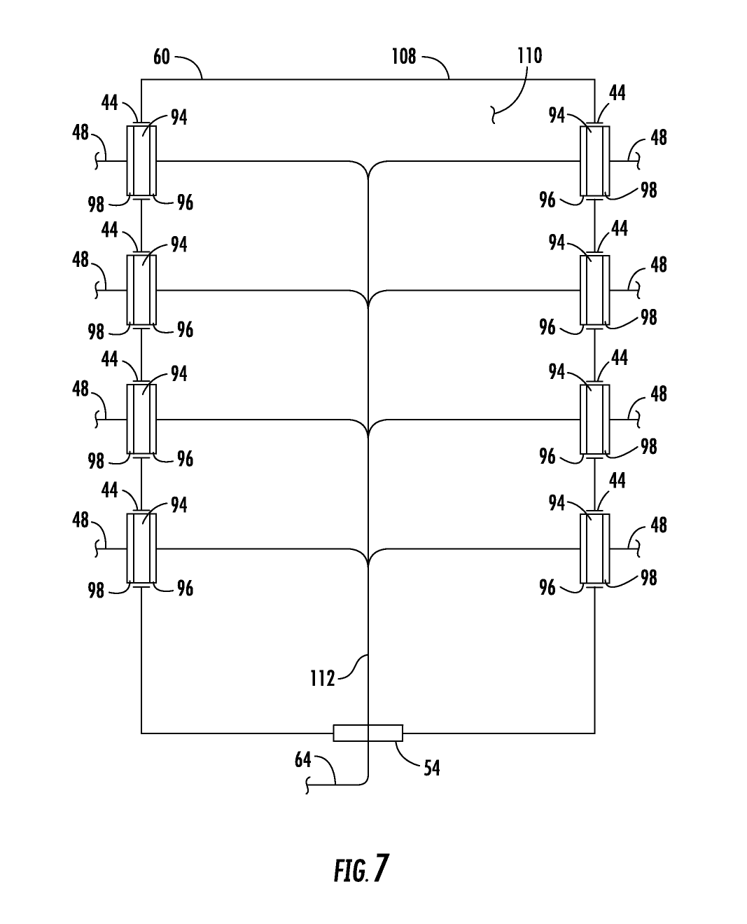

Referring now to FIGS. 7, 8 and 9, there are shown schematic diagrams of drop terminals 60, 61 and 63, respectively. Each drop terminals 60, 61 and 63 has an enclosure 108 defining an interior 110. The series cable 64 may have a single optical fiber or any number of optical fibers such as four to eight optical fibers. The series cable 64 enters the drop terminal 60, 61 and 63 through the network port 54 in the enclosure 108. The jacket of the series cable 64 may be stripped off in the interior 110 such that the optical fibers 112 of the series cable 64 may be loose to facilitate routing within the interior 110 as necessary to configure the drop terminals 60, 61 and 63.

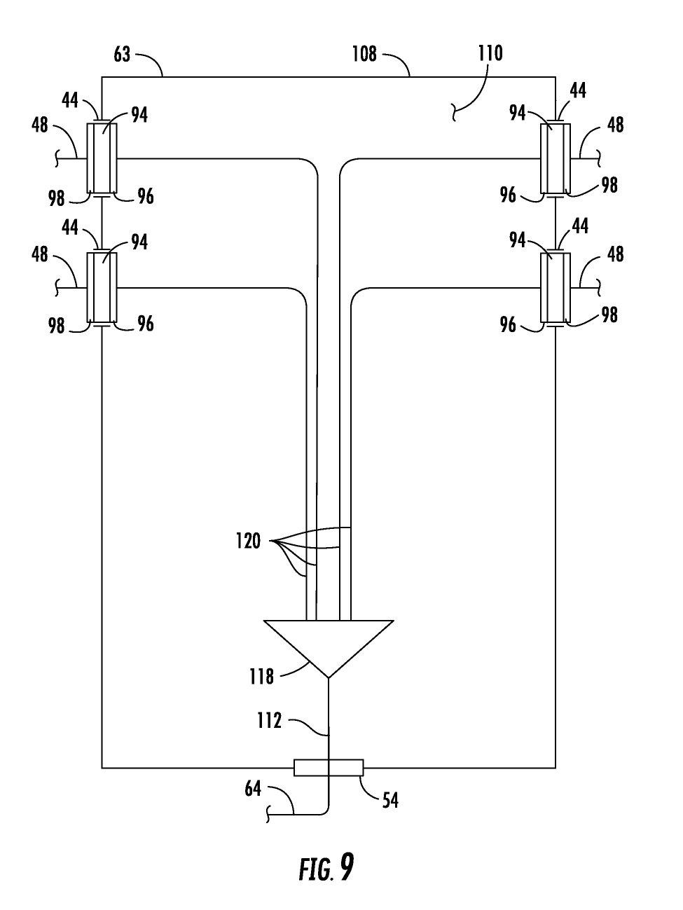

FIG. 7 illustrates the drop terminal 60 included in the configuration of “Zone 1” 12. In FIG. 7 the series cable 64 has eight optical fibers 112. Each of the optical fibers 112 routes to respective drop ports 44 for connection to a drop cable 48. The drop cables 48 may then extend to subscriber premises, such as a single family unit 20. FIG. 8 shows drop terminal 61 included in the configuration of “Zone 2” 14. In FIG. 8, series cable 64 has one optical fiber 112. The optical fiber 112 routes to a 1×8 splitter 114 whereupon the optical signal in the optical fiber 112 is split into eight optical signals. Each optical signal is carried by one pigtail optical fiber 116 thereby resulting in eight pigtail optical fibers 116 each of which routes to a drop port 44 for connection to a drop cable 48. The drop cables 48 may then extend to subscriber premises, such as a single family unit 20. FIG. 9 shows a drop terminal 63 included in the configuration of “Zone N” 16. Similar to the drop terminal 61 in FIG. 8, drop terminal 63 has a splitter. In FIG. 9, though, the splitter is a 1×4 splitter 118 which splits the optical signal carried by the optical cable 112 into four optical signals. Each optical signal is carried by one pigtail optical fiber 120 thereby resulting in four eight pigtail optical fibers 120 each of which routes to a drop port 44 for connection to a drop cable 48. The drop cables 48 may then extend to subscriber premises, such as a single family unit 20.

Although optical splitters are included in the embodiment shown in FIGS. 6, 8 and 9 illustrating series-connected terminal 59, drop terminal 61 and drop terminal 63, it should be understood that the zone terminal 34, branch-connected terminal 49, and other series-connected and drop terminals may include one or more splitters. Additionally, the optical splitters may provide for any ratio of splitting including, without limitation 1×4, 1×6, 1×8, 1×16 and 1×32. Further, a plurality of optical splitters may be connected in a cascaded fashion with the output of one splitter connected to the input of another splitter. Also, although the splicing hardware 82 is shown in the embodiment of zone terminal 34 in FIG. 1, it should understood that splicing hardware 82, as well as any other fiber optic components, including but not limited to routing guides, slack storage, and wave division multiplexers, may be included in branch-connected terminal 49, series-connected terminal 58, 59 and drop terminal 60, 61, 63. Further, the optical splitters, and/or other components, may be cassette mounted for ease of and minimal cost installation. In this manner, for example, a cassette splitter may be mounted in the branch-connected and/or series connected terminals but not connected until the zone needs to be reconfigured do to a change in subscriber take rate. At that time, the service provider can just connect the cassette splitter to provide for optical communication service to additional subscribers.

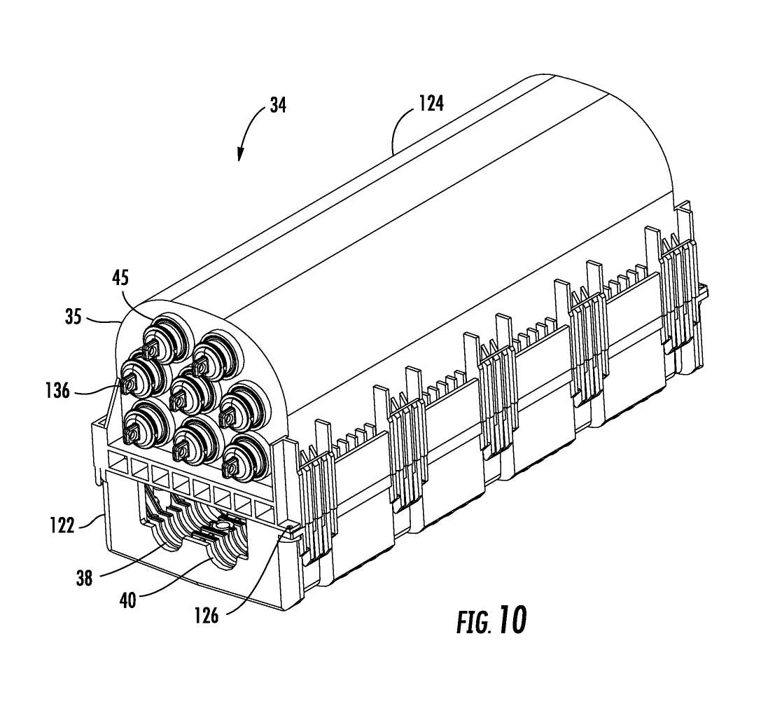

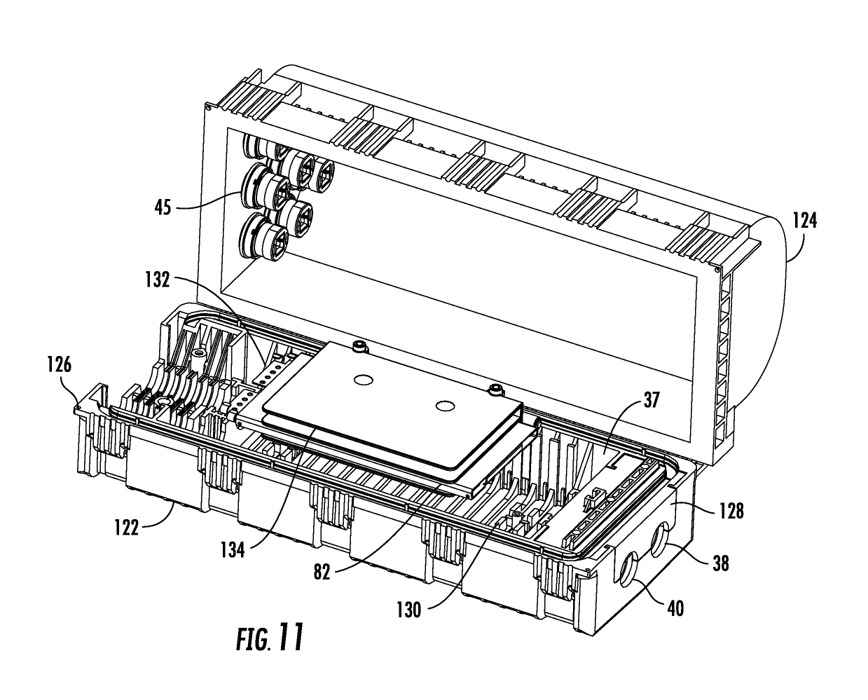

Referring now to FIGS. 10 and 11, the zone terminal 34 is shown. The zone terminal 34 comprises an enclosure 35 having a base 122 and a cover 124 each made of a lightweight, yet rigid material, such as aluminum, plastic or thermoplastic. FIG. 10 shows the cover 124 in a closed position, while FIG. 11 shows the cover 124 in an opened position. The base 122 and the cover 124 together are generally “lunch pail” shaped and define an interior 37. The cover 124 may have any shape that is suitable for housing a plurality of branch ports 42 and/or drop ports 44 located within an external wall of the enclosure 35. As shown, the cover 124 is generally arcuate and dome-shaped and is hingedly affixed to the base 122 along the upper edge of one of the sidewalls at one or more hinge locations and secured to the base 122 at openings 126 that receive threaded screws or bolts, or other known fasteners to secure the cover 124 in the closed position. A sealing gasket (not shown) may also be disposed between the base 122 and the cover 124 to provide a seal against environmental elements such as wind-driven rain.

The embodiment of the zone terminal 34 shown in FIGS. 10 and 11 may be installed in a below grade location, for example, within a hand-hole or vault, an aerial location, for example, on a telephone pole, or in an above ground location. The base 122 and an end wall 128 (removed from the base 122 in FIG. 9) define the upstream cable port 38 and downstream cable port 40 for receiving at least one distribution cable 32 through the wall of the enclosure 35. As shown, the end wall 128 is inserted into grooves defined by the base 122 and secured in place around the distribution cable 32 (not shown in FIGS. 10 and 11). Fasteners (not shown), such as threaded screws or bolts, may be used to secure the end wall 128 to the base 122. The fasteners may only be accessed when the cover 124 is in an opened position. The base 122 and the end wall 128 may also be provided with a water-blocking gel material that provides a sealing function.

Referring specifically to FIG. 11, the zone terminal 34 is illustrated with the cover 124 opened to show the interior 37 of the enclosure 35 and its contents. Although not shown, the distribution cable 32 enters the zone terminal 34 through the upstream cable port 38 located within one or both end walls 128 and exits the zone terminal 34 through a downstream cable port 40 located within the same and/or opposed end wall 128. The distribution cable 32 may be secured to one or more cable brackets positioned adjacent to the appropriate cable ports 38, 40 and secured by the base 122 or end wall 128. The cable bracket may define a notch along its length for securing a conventional cable tie, strap, hose clamp or other fastening mechanism around the distribution cable in a known manner. The cable bracket also aids in retaining the zone terminal 34 in place in a desired position along the length of the distribution cable 32. A plurality of hardware mounting features 130 may be located on the interior 37 for fastening optical hardware, such as optical fiber storage trays, splice trays, splitters, routing guides, fiber organizers, etc., to the interior 37. A slack basket (not shown) may be fastened to the hardware mounting features 130 and operable for receiving and storing slack lengths of optical fibers and/or optical fiber buffer tubes. A strain relief bracket 132 may also be secured to the interior 37 using the hardware mounting features 130. The strain relief bracket 132 (which may also be a part of a splice tray) provides strain relief for the optical fibers entering and exiting, for example, splice hardware 82 such as a splice tray. Splice trays are used when terminated or preterminated optical fibers are spliced in the field, such as when one or more optical fibers of the distribution cable 32 are accessed in the field to create a mid-span access location and spliced to interconnect the distribution cable with one or more branch cables 46, sub-branch cables 56, series cables 64 and/or drop cables 48, which hereinafter shall be referred to collectively as preconnectorized cables.

The connectors (not shown) of the connectorized optical fibers are routed within the interior 37 and connected to the branch ports 42 and/or cable ports 44 (hereinafter referred to collectively as connector ports 45) on the inside of the enclosure 35. Although not shown, strain relief devices may be provided for any of the optical fibers within the interior 37 to strain relieve the optical fibers adjacent the distribution cable 32. With the cover 124 opened as shown in FIG. 11, the interior 37 is readily accessible to a field technician initially installing the connectorized optical fibers into the respective connector ports 45. The field technician may create and route additional connectorized optical fibers to unused connector ports 45, or remove or rearrange optical connections between existing connectorized optical fibers and the connector ports 45. Once the zone terminal 34 is initially installed, the field technician may also add, remove or rearrange optical connections between optical fibers of the preconnectorized cables and the respective connector ports 35 from the exterior of the zone terminal 34 without the need for entering the enclosure 35. Since the zone terminal 34 does not have to be entered to connect, disconnect or reconfigure preconnectorized cables, additional preconnectorized cables can be connected without disturbing the previously installed preconnectorized cables or the contents of the zone terminal 34.

A shelf 134 may be used to mount conventional splicing hardware 82, such as a splice tray, or other optical components, including, without limitation, a splitter, within the interior 37. The splicing hardware 82 may be used to splice terminated or preterminated optical fibers 80 of the distribution cable 32 to pigtail optical fibers 86. The splice hardware 82 may be mounted to either the top or bottom surface of the shelf 134, or as shown, within a slot provided on the shelf 134. As shown, the shelf 134 is secured by conventional fasteners to an interior wall of the base 122 at one or more locations.

The embodiment of the zone terminal 34 illustrated in FIGS. 10 and 11 comprises eight connector ports 45 for receiving up to eight connectorized optical fibers on the inside of the zone terminal 34 and up to eight pre-connectorized cables on the outside of the zone terminal 34. Although the eight connector ports 45 are shown arranged in an arcuate pattern, it is envisioned that the zone terminal 34 may be designed to accommodate any desired number of connector ports 45, for example, one, two, three, four, six, eight, etc., on one or both ends of the zone terminal 34. Further, the upstream cable port 38 and the downstream cable port 40 may be connector ports 45. Thus, it is conceivable that the zone terminal 34 may accommodate any desired number of pre-connectorized cables. Furthermore, the dimensions and overall size of the connection closure 20 will vary depending on the number of connector ports 34 utilized.

The connector ports 45 may also include multi-fiber adapters 74 and/or single fiber adapters 94 (not shown) for aligning and maintaining the mating connectors in physical contact. The connector ports 45 further provide an environmental seal at the interface between the connectorized optical fibers of the distribution cable 32 and the pre-connectorized cables. Unused connector ports 45 may be covered and sealed with a removable cap or plug 136 until the connector port 45 is needed.

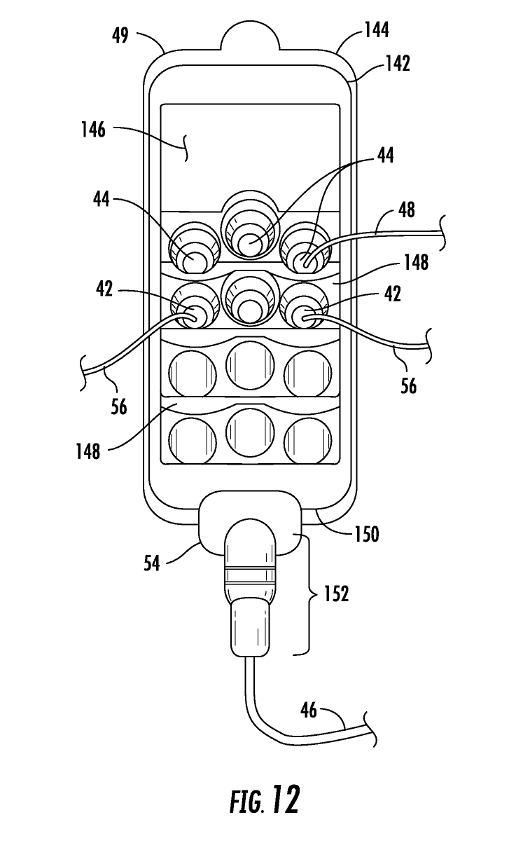

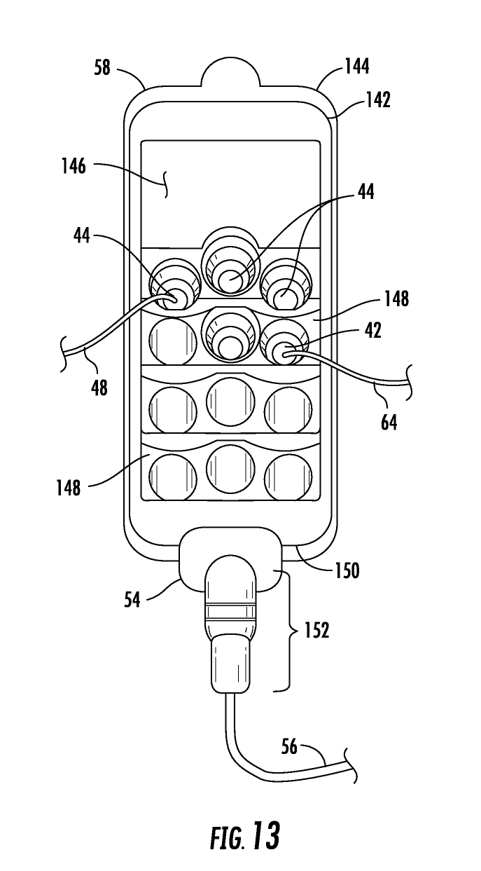

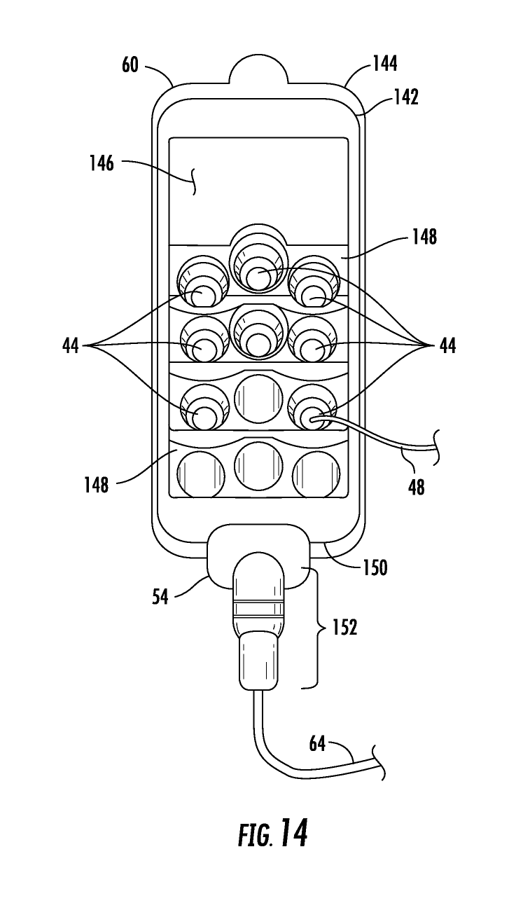

Turning now to FIGS. 12, 13 and 14, exemplary embodiments of optical terminals that may be used as a branched-connected terminal 49, series-connected terminals 58, 59 and drop terminals 60, 61, 63, respectively are shown. As shown in FIGS. 12, 13 and 14, the optical terminals comprise a base 142 and a cover 144 each made of a lightweight, yet rigid material, such as plastic, thermoplastic, composite or aluminum material. The base 142 and the cover 144 define an enclosure having an exterior surface 146. The exterior surface 146 is provided with a plurality of angled or sloped surfaces 148. One or more angled surfaces 148 may have a branch port 42 or a drop port 44. The base 142 may have any of a variety of shapes that is suitable for housing fiber optic hardware, including but not limited to splitters and splicing hardware 82 and for routing and connecting optical fibers of the branch cable 46, sub-branch cable 56 and/or series cable 64. However, by way of example only, the base 142 of this embodiment is generally rectangular and is elongated in the lengthwise direction relative to the widthwise direction.

A network port 54 is disposed through the exterior surface 146. Although the network 54 may be at any position through the exterior surface, in the embodiment shown, the network port 54 is disposed in an end wall 150 of the base 142. The branch network port 54 is operable for receiving a cable assembly 152 comprising the branch cable 46, sub-branch cable 56 or series cable 64 depending on whether the optical terminal is used a branched-connected terminal 49, series-connected terminals 58, 59 and drop terminals 60, 61, 63, respectively. The cable assembly 152 is inserted through the network port 54. The cable assembly 152 may be any type of assembly or structure that provides for the entrance of a fiber optic cable into the optical terminal, and the sealing of the cable as it enters the optical terminal. Additionally, the cable assembly 152 may provide strain relief to the cable as is known in the art. Alternatively, a ruggedized multi-fiber connector 74 (not shown) may be used to connect the branch cable 46, sub-branch cable 56 or series cable 64 to the optical terminal. In such case, instead of the cable assembly 152 as depicted in FIGS. 12, 13, 14, the ruggedized multi-fiber connector 74 may be connected to a multi-fiber adapter 72 seated within the network port 54. Another multi-fiber connector 76 (not shown) may be used to connect to the multi-fiber adapter 72 in the interior, thereby optically connecting the optical fibers of the branch cable 46, sub-branch cable 56 or series cable 64 to optical fibers disposed within the optical terminal.

The cover 144 is adapted to be attached to the base 142 such that the optical terminal is re-enterable to provide ready access to the interior, particularly in the field, if necessary to reconfigure the optical fibers of the branch cable 46, sub-branch cable 56 or series cable 64. The base 142 and cover 144 may be provided with a fastening mechanism such as, but not limited to, clasps, fasteners, threaded bolts or screws and inserts, or other conventional means for securing the cover 144 to the base 142 in the closed configuration. However, the cover 144 may be slidably attached to the base 142 to selectively expose portions of the interior of the base 142. Alternatively, the cover 144 may be hingedly attached to the base 142 at one or more hinge locations (not shown) to allow the cover 144 and base 142 to remain secured to one another in the opened configuration. A gasket (not shown) may be disposed between a peripheral flange provided on the base 142 and the interior of the cover 144. Alternatively, in certain locations the service provider may determine that it is not desirable that optical terminal be enterable in the field, and, therefore, may decide to fasten the base 142 to the cover 144 by welding, for example using an epoxy type of weld.

A sub-branch cable 56 or series cable 64 terminated with ruggedized multi-fiber connectors 74 may also extend from a branch connector port 42. In such a case, a multi-fiber adapter 72 may be seated in the branch port 42. Alternatively or additionally, if the sub-branch cable 56 and/or the series cable 64 has only a single optical fiber, they may be terminated with ruggedized single fiber connectors 96 may also extend from a branch port 42. In such a case, a single fiber adapter 94 may be seated in the branch connector port 42. Further, a single fiber drop cable 48 terminated with a ruggedized single fiber connector 96 may extend from a drop port 44. In such a case, a single fiber adapter 94 may be seated in the drop port 42. In the case of a multi-fiber drop cable 48, the drop cable 48 may be terminated with a ruggedized multi-fiber connector 74. In such a case, a multi-fiber adapter 72 may be seated in the drop port 42. The branch cable 46, sub-branch cable 56, series cable 64 and drop cable 48 may be connectorized or pre-connectorized with any suitable ruggedized connector, for example, an OptiTap® or OptiTip® connector available from Corning Cable Systems LLC of Hickory, N.C.

Many other modifications and embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

What is claimed is:

1. A fiber optic terminal, comprising:
an enclosure having a wall defining an interior cavity and a plurality of connector ports disposed through the wall, wherein the enclosure receives a distribution cable optically connected to a service provider's optical feeder cable;
at least one adapter positioned within one of the plurality of connector ports, wherein the at least one adapter has an interior end accessible from within the interior cavity and an exterior end accessible external to the enclosure, and wherein the adapter is configured to establish an optical connection between at least one optical fiber attached to a first multi-fiber optical connector inserted in the interior end, and one or more respective optical fibers in a second multi-fiber optical connector, wherein the respective one or more respective optical fibers are optically connected to one or more optical fibers of the distribution cable, and wherein the second multi-fiber optical connector is suitable for outside-plant installation, and wherein the terminal is configured to extend optical service from a service provider toward at least one subscriber premises in a zone, and wherein the fiber optic terminal is reconfigurable based on at least one of, a number of subscriber premises in the zone, a geographical relationship of the subscriber premises in the zone, and a demographic make-up of the subscriber premises in the zone.

2. The terminal of claim 1, wherein the configuring includes splicing hardware positioned in the enclosure, wherein the at least one optical fiber attached to the first multi-fiber optical connector routes to the splicing hardware and connects to a respective pigtail optical fiber.

3. The terminal of claim 1, wherein the configuring includes a 1×N splitter, and wherein an optical signal carried by the optical fiber in the first fiber optic cable is split into N optical signals, and wherein at least one of the N optical signals is carried by the respective optical fiber in the second fiber optic cable.

4. The terminal of claim 3, wherein N equals one of 4. 8, 16 and 32.

5. The terminal of claim 3 or 4, further comprising a plurality of 1×N splitters.

6. The terminal of claim 5 wherein the at least two of the plurality of 1×N splitters are interconnected in a cascaded arrangement wherein an output of one of the at least two 1×N splitters optically connects to an input of another of the at least two 1×N splitters.

7. The terminal of claim 1, wherein the second fiber optic cable extends to a second fiber optic terminal.

8. The terminal of claim 1, wherein the second fiber optic cable is a drop cable extending to equipment at the subscriber's premises.

9. The terminal of claim 1, wherein the demographic make-up comprises at least one multiple dwelling unit.

10. The terminal of claim 1, wherein the demographic make-up comprises at least one single family dwelling.

11. The terminal of claim 1, wherein the demographic make-up comprises at least one commercial building.

12. The terminal of claim 1, wherein the terminal provides for plug and play connection.

13. A multi-zoned fiber optic network, comprising:
a first zone, wherein the first zone is configured to provide optical service from an optical service provider to at least one subscriber premises in the first zone, the first zone, comprising, at least one first terminal having an enclosure having a wall defining an interior cavity and a plurality of connector ports disposed through the wall, and at least one adapter positioned within one of the plurality of connector ports, wherein the at least one adapter has an interior end accessible from within the interior cavity and an exterior end accessible external to the enclosure, and wherein the adapter is configured to establish an optical connection between at least one optical fiber in a first multi-fiber optical connector attached to the end of a first fiber optic cable and inserted in the interior end, and one or more respective optical fibers in a second multi-fiber optical connector, wherein the one or more respective optical fibers are optically connected to one or more optical fibers of a first distribution cable, and wherein the second multi-fiber optical connector is suitable for outside-plant installation, and
wherein the first zone is reconfigurable based on at least one of, a number of subscriber premises in the first zone, a geographical relationship of the subscriber premises in the first zone, and a demographic make-up of the subscriber premises in the first zone; and
a second zone, wherein the second zone is configured to provide optical service from an optical service provider to at least one subscriber premises in the second zone, the second zone, comprising, at least one second terminal having an enclosure having a wall defining an interior cavity and a plurality of connector ports disposed through the wall, and at least one adapter positioned within one of the plurality of connector ports, wherein the at least one adapter has an interior end accessible from within the interior cavity and an exterior end accessible external to the enclosure, and wherein the adapter is configured to establish an optical connection between one or more respective optical fiber in a third multi-fiber optical connector, wherein the one or more respective optical fibers are optically connected to one or more optical fibers of a second distribution cable attached to the end of a third fiber optic cable and inserted in the interior end, and one or more respective optical fibers in a fourth multi-fiber optical connector, wherein the one or more respective optical fibers are optically connected to one or more optical fibers of a second distribution cable, and wherein the fourth multi-fiber optical connector is suitable for outside-plant installation, and
wherein the second zone is reconfigurable based on at least one of, a number of subscriber premises in the second zone, a geographical relationship of the subscriber premises in the second zone, and a demographic make-up of the subscriber premises in the second zone.

14. The fiber optic network of claim 13, wherein the demographic make-up comprises at least one multiple dwelling unit.

15. The fiber optic network of claim 13, wherein the demographic make-up comprises at least one single family dwelling.

16. The fiber optic network of claim 13, wherein the demographic make-up comprises at least one commercial building.

17. The fiber optic network of claim 13, wherein the first zone is reconfigured by including a plurality of first terminals.

18. The fiber optic network of claim 13 or 17, wherein the first zone is reconfigured by including a 1×N splitter in the first terminal, wherein an optical signal carried by the optical fiber in the first fiber optic cable is split into N optical signals, and wherein at least one of the N optical signals is carried by the respective optical fiber in the second fiber optic cable.

19. The fiber optic network of claim 13, wherein the second zone is reconfigured by including a plurality of second terminals.

20. The fiber optic network of claim 13 or 19, wherein the second zone is reconfigured by including a 1×N splitter in the second terminal, wherein an optical signal carried by the optical fiber in the third fiber optic cable is split into N optical signals, and wherein at least one of the N optical signals is carried by the respective optical fiber in the fourth fiber optic cable.
